(19) United States
(12) Patent Application Publication
(10) Pub. No.: US 2014/0257732 A1
(43) Pub. Date: Sep. 11, 2014

(54) SYSTEM AND METHOD FOR MACHINE INCLINATION MEASUREMENT

(71) Applicant: CATERPILLAR INC., Peoria, IL (US)

(72) Inventor: Ryan A. Kingdon, Peoria, IL (US)

(73) Assignee: CATERPILLAR INC., Peoria, IL (US)

(21) Appl. No.: 13/784,971

(22) Filed: Mar. 5, 2013

(51) Int. Cl. G01C 25/00

(52) U.S. Cl. CPC G01C 25/005
USPC 702/94

(57) ABSTRACT

A system for a machine having an implement and operating on a slope is provided. The system includes an implement position sensor, inclination sensor and an inclination module. The implement position sensor is configured to generate a signal indicative of a position of the implement relative to a frame of the machine. The inclination sensor, mounted on the implement, is configured to generate a signal indicative of an inclination of the implement relative to the frame of the machine. The inclination module is configured to receive the signals. The inclination module is also configured to correlate the position of the implement and the inclination of the implement with a predefined dataset to determine a bias factor associated with the implement. Further, the inclination module is configured to determine an inclination angle of the slope based on the determined bias factor.

### TECHNICAL FIELD

The present disclosure relates to an inclination measurement system and more particularly to a system and method for measuring an inclination of a slope on which a machine is operating.

### BACKGROUND

Generally an inclination of a machine with respect to horizontal ground may be determined by installing an inclination measurement device such as, for example, an inclinometer on the machine. In some machines like for example, a wheel tractor scraper, a reading of the inclination measurement device may be biased by a work tool present on the machine. Hence, in order to obtain a corrected inclination of the machine with respect to the horizontal ground, a correction factor must be applied to the reading.

U.S. Pat. No. 7,650,252 relates to a system and a method to sense an inclination of a machine element, such as a platform, and eliminate tangential and radial acceleration errors. The platform defines orthogonal X and Y axes, and is rotatable about a Z axis. An inclinometer mounted on the platform at a location spaced from the axis of rotation by a distance r, provides inclinometer outputs indicating acceleration in the X and Y directions, Ix and Iy, respectively. A rate gyro on the platform senses the rotational speed w of the platform. The rate gyro output w is differentiated and multiplied by r to determined tangential acceleration at the inclinometer. A circuit resolves the tangential acceleration into X axis and Y axis components, which are used to correct the inclinometer outputs Ix and Iy for errors that would otherwise result from tangential acceleration.

There is a need to provide an improved and simplified approach of measuring a relatively accurate inclination of the machine with respect to the horizontal ground in the machines in which the work tool may bias the inclination reading.

### SUMMARY OF THE DISCLOSURE

In one aspect of the present disclosure, a system for a machine operating on a slope is provided. The machine has an implement. The system includes an implement position sensor and an inclination sensor. The implement position sensor is configured to generate a signal indicative of a position of the implement relative to a frame of the machine. The inclination sensor is mounted on the implement. The inclination sensor is configured to generate a signal indicative of an inclination of the implement relative to the frame of the machine. The system also includes an inclination module communicably connected to the implement position sensor and the inclination sensor. The inclination module is configured to receive the signal indicative of the position of the implement relative to the frame of the machine and the signal indicative of the inclination of the implement relative to the frame of the machine. The inclination module is also configured to correlate the position of the implement and the inclination of the implement with a predefined dataset to determine a bias factor associated with the implement. Further, the inclination module is configured to determine an inclination angle of the slope based on the determined bias factor.

In another aspect of the present disclosure, a method for a machine operating on a slope is provided. The machine has an implement. The method receives, from an implement position sensor, a signal indicative of the position of the implement relative to a frame of the machine. The method receives, from an inclination sensor mounted on the implement, a signal indicative of an inclination of the implement relative to the frame of the machine. The method correlates the position of the implement and the inclination of the implement with a predefined dataset to determine a bias factor associated with the implement. Further, the method determines an inclination angle of the slope based on the determined bias factor.

Other features and aspects of this disclosure will be apparent from the following description and the accompanying drawings.

### BRIEF DESCRIPTION OF THE DRAWINGS

FIG. 1 is a side view of an exemplary machine operating on horizontal ground, according to one embodiment of the present disclosure;

FIG. 2 is a side view of the machine operating on a slope;

FIG. 3 is a block diagram of an inclination measurement system; and

FIG. 4 is a flowchart for determining an inclination angle of the slope shown in FIG. 2.

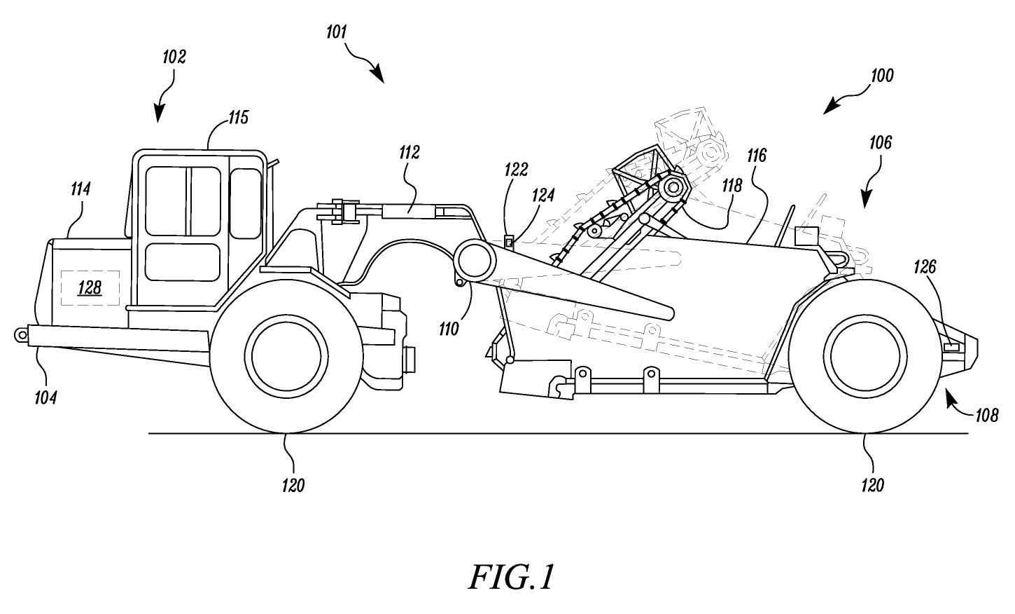

### DETAILED DESCRIPTION

Wherever possible, the same reference numbers will be used throughout the drawings to refer to the same or like parts. FIG. 1 depicts an exemplary machine 100, according to one embodiment of the present disclosure. More specifically, the machine 100 may embody a wheel tractor scraper 101. A person of ordinary skill in the art will appreciate that the machine 100 depicted in the accompanying figures is merely on an exemplary basis. It should be noted that the disclosure can be applied to any number of different types of machines used in construction, transportation, agriculture and industry. For example, the machine 100 may be a motor grader, wheel harvester, rotary mixer, wheel skidder, four-wheel drive vehicle, wheel loader or other machine having an implement which may bias a reading provided by an inclination sensor installed on the machine 100.

Referring to FIG. 1, the wheel tractor scraper 101 includes a tractor portion 102 with a front frame section 104, and a scraper portion 106 with a rear frame section 108, that are pivotally coupled through an articulation hitch 110. One or more steering cylinders 112 may be mounted between the tractor portion 102 and the scraper portion 106, on opposing sides of the wheel tractor scraper 101. As shown, the front frame section 104 may have an enclosure 114. A power source may be installed inside the enclosure 114 to provide power for propulsion of the machine 100. The power source may include for example, a diesel engine, a gasoline engine, a gaseous fuel powered engine such as a natural gas engine, a combination of known sources of power or any other type of power source apparent to one of skill in the art. The power source may alternatively include a non-combustion source of power such as a fuel cell, a power storage device, an electric motor, or other similar mechanism. The front frame section 104 may also support an operator station 115. Also, the machine 100 may be mounted on a set of ground engaging members 120, such as wheels, for mobility.

In one embodiment, as shown in FIG. 1, the rear frame section 108 may support a bowl 116. The bowl 116 may further include a fluid powered work tool such as an elevator 118. Alternatively, an auger, a conveyor, a spade, and the like, may be used. Material may be loaded into the bowl 116 during operation of the elevator 118. For the purpose of this disclosure the bowl 116 of the wheel tractor scraper may be interchangeably referred to as an implement 116 of the machine 100.

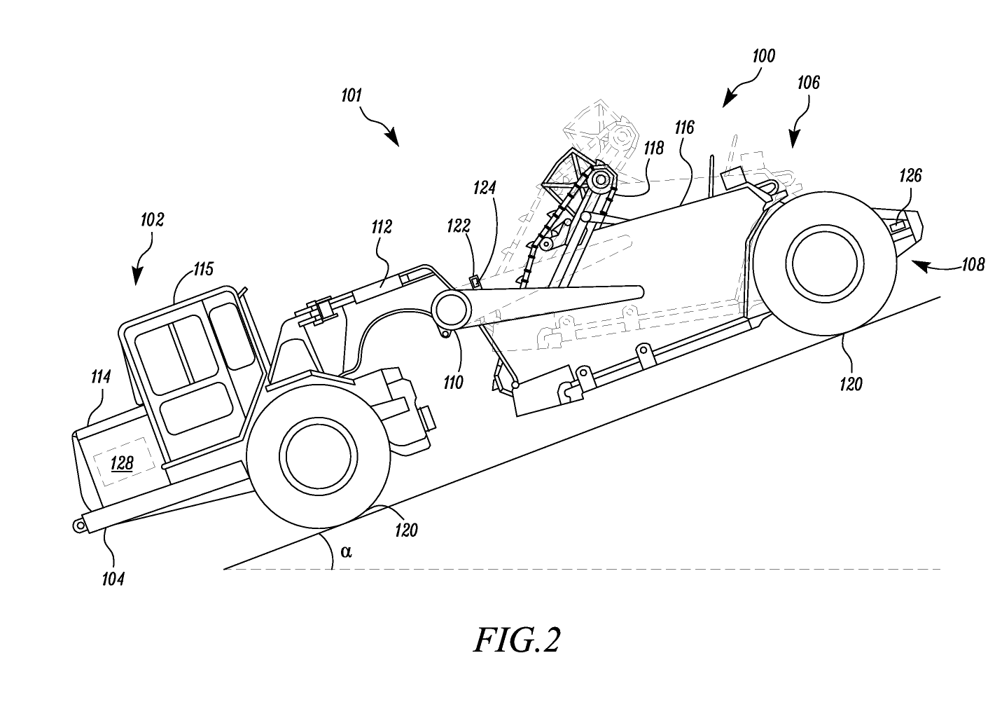

More specifically, a set of hydraulic or pneumatic cylinders 122 may be coupled to the implement 116. During operation, the implement 116 is capable of vertical movement relative to the frame of the machine 100 by extension of the cylinders 122. Accordingly, there may be several positions of the implement 116 relative to the frame of the machine 100, based on the length of extension of the cylinders 122. The movement of the implement 116 is shown using dotted lines in FIGS. 1 and 2.

In one embodiment, an implement position sensor 124 may be mounted on the machine 100, such that the implement position sensor 124 is configured to generate a signal indicative of the position of the implement 116 relative to the frame of the machine 100. For example, the implement position sensor 124 may include a positioning sensor mounted on the cylinders 122 which is configured to generate a signal indicative of the length of extension of the cylinders 122 based on a current position of the implement 116. Alternatively, the position of the implement 116 may be ascertained using any other computed or measured signals by techniques known in the art.

Further, an inclination sensor 126 may be mounted on the implement 116 of the machine 100. The inclination sensor 126 may include an inclinometer. Alternatively, the inclination sensor 126 may include an accelerometer, a gyro meter, a magnetometer, an orientation sensor, a level gauge/spirit level, or any other known device known in the art. The inclination sensor 126 is configured to generate a signal indicative of an inclination of the implement 116 relative to the frame of the machine 100.

Referring to FIG. 2, the machine 100 is capable of operation on a slope, which forms an inclination angle α with horizontal ground. The present disclosure relates to an inclination module 128 mounted within the machine 100. The inclination module 128 is configured to determine the inclination angle α of the slope. It should be noted that the inclination angle α of the slope may be equivalent to the angle at which the machine 100 or a lower surface of the wheels of the machine 100 are positioned with respect to the horizontal ground.

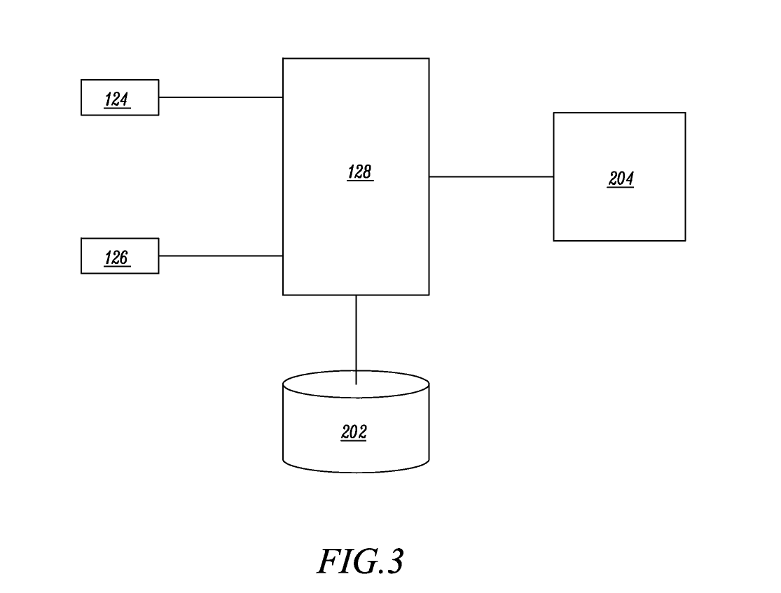

FIG. 3 illustrates a block diagram of the system including the inclination module 128, the implement position sensor 124 and the inclination sensor 126. As shown, the inclination module 128 is communicably connected to the implement position sensor 124. The inclination module 128 is configured to receive the signal indicative of the position of the implement 116 relative to the frame of the machine 100. Further, the inclination module 128 may also be communicably connected to the inclination sensor 126. The inclination module 128 may receive the signal indicative of the inclination of the implement 116 relative to the frame of the machine 100 from the inclination sensor 126.

One of ordinary skill in the art will appreciate that in some machines like for example, a flat bedded truck, the signal generated by any inclination measuring device is indicative of the inclination of the machine with respect to the horizontal ground. In such machines, the implement or the work tool present on the machine does not bias a reading of the inclination measuring device. However, in certain other machines, like the wheel tractor scraper 101 described herein, the implement 116 may bias the reading of the inclination sensor 126.

In the present disclosure, the inclination angle α of the slope may be ascertained by determining a bias factor associated with the implement 116. When the machine 100 is operating on the slope, this bias factor may be applied to the reading of the inclination sensor 126 in order to determine the inclination angle α of the slope, based on the position of the implement 116 at that time. It should be noted that the inclination of the machine 100 with respect to the horizontal ground may be approximately same as that of the inclination angle α of the slope.

As shown in FIG. 3, the inclination module 128 may be coupled to a database 202. The database 202 may be any conventional database known to one skilled in the art. The database 202 may be extrinsic or intrinsic to the inclination module 128. The database 202 is configured to store a predefined dataset. The predefined dataset may contain a plurality of readings of the inclination of the implement 116 relative to the frame of the machine 100 corresponding to one or more positions of the implement 116 relative to the frame of the machine 100. These readings are recorded when the machine 100 is operating on the horizontal ground. Data stored in the predefined dataset may include a set of numerical and/or alphanumerical values, space co-ordinates and/or a combination thereof

It should be understood that ideally when the machine 100 is operating on the horizontal ground the inclination of the machine 100 should be zero irrespective of the position of the implement 116 at that time. However, due to the bias introduced by the implement 116, the readings recorded by the inclination sensor 126 may deviate from zero for each of the different positions of the implement 116. It should be noted that the bias factor associated with the implement 116 may vary based on the position of the implement 116.

More specifically, in the present disclosure, when the machine 100 is operating on the slope, the inclination module 128 may be configured to correlate the signals received from the implement position sensor 124 and the inclination sensor 126 with the corresponding data in the predefined dataset to determine the bias factor based on the position of the implement 116 at that time. In one embodiment, the inclination module 128 may retrieve the corresponding reading recorded by the inclination sensor 126 which are stored in the database 202 based on the position of the implement 116. Accordingly, the inclination module 128 may determine the bias factor associated with the implement 116.

Further, the inclination module 128 may apply the determined bias factor to the signal received from the inclination sensor 126. The inclination module 128 may hence determine the inclination angle α of the slope based on the determined bias factor. The inclination module 128 may further be communicably connected to a display device 204, in order to notify an operator of the inclination angle α of the slope. The display device 210 may be a CRT monitor, LCD monitor, LED monitor, plasma monitor, a touchscreen display or the like known to one skilled in the art.

The inclination module 128 may embody a single microprocessor or multiple microprocessors that include a means for receiving input from the implement position sensor 124 and the inclination sensor 126 in order to determine the inclination angle α of the slope. Numerous commercially available microprocessors may be configured to perform the functions of the inclination module 128. It should be appreciated that the inclination module 128 may readily embody a general machine microprocessor capable of controlling numerous machine functions. A person of ordinary skill in the art will appreciate that the inclination module 128 may additionally include other components and may also perform other functionality not described herein. Further, the connections and sensors described herein are merely on an exemplary basis and do not limit the scope of the disclosure.

### INDUSTRIAL APPLICABILITY

The inclination of a machine with respect to the horizontal ground for activities like construction, agriculture, mining, and the like may need to be known for a variety of reasons. For example, this information may be needed to determine appropriate working conditions of the machine and/or the implement, suitable material handling limits, power required to maneuver the machine on different operating terrains, and the like. Different sensors such as, for example, an inclinometer, an accelerometer, a gyro meter, and the like may be mounted on the machine for this purpose.

However, in case of some machines, these sensors may provide inaccurate readings due to a bias caused by the implement attached to the machine. The present disclosure provides the inclination module 128 for the machine 100 operating on the slope. The inclination module 128 may determine the inclination angle α of the slope, which is approximately same as the inclination of the machine 100 with respect to the horizontal ground. As described earlier, the inclination module 128 may determine the bias factor based on the current position of the implement 116 and the predefined dataset.

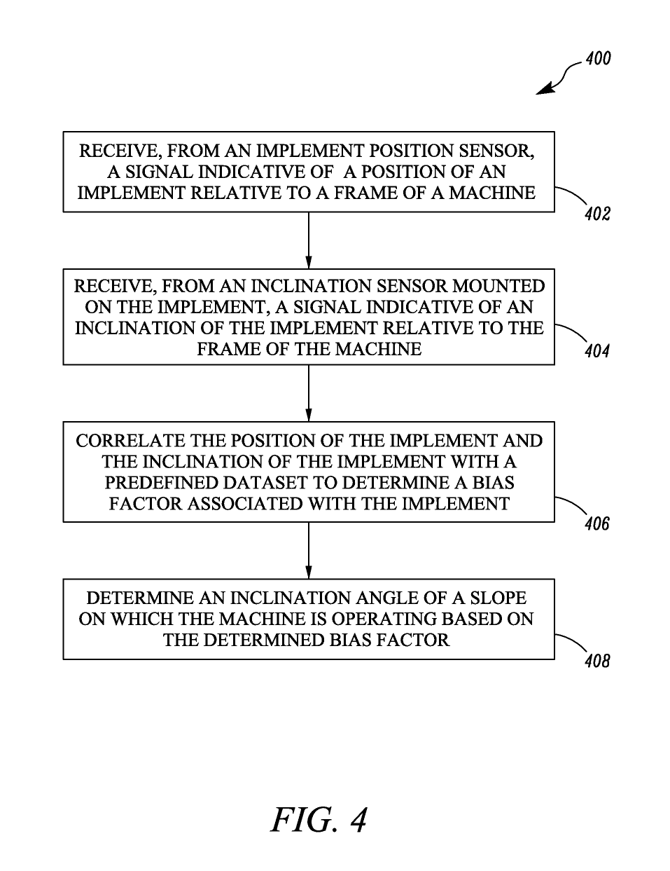

Referring to FIG. 4, at step 402, the inclination module 128 may receive the signal indicative of the position of the implement 116 relative to the frame of the machine 100. At step 404, the inclination module 128 may receive the signal indicative of the inclination of the implement 116 relative to the frame of the machine 100. Thereafter, at step 406, the inclination module 128 may correlate the position of the implement 116 and the inclination of the implement 116 with the predefined dataset to determine the bias factor associated with the implement 116.

It should be noted that the predefined dataset includes pre-calibrated readings of the different positions of the implement 116 and the corresponding readings of the inclination of the implement 116 measured by the inclination sensor 126, when the machine 100 is operating on the horizontal ground. The deviation of these inclination readings from zero are indicative of the bias factor introduced by the implement 116. More importantly, the bias factor may vary based on the position of the implement 116. Hence, the inclination module 128 may look-up the predefined dataset stored in the database 202 and accordingly determine the bias factor based on the current position of the implement 116, when the machine 100 is operating on the slope.

The inclination module 128 may then apply the determined bias factor to the inclination reading received from the inclination sensor 126. At step 408, the inclination module 128 may determine the inclination angle α of the slope. In one embodiment, the inclination angle α of the slope may be displayed on the display device 210 in order to notify the operator. In another embodiment, the inclination angle α of the slope may be used as input to other control systems present on the machine 100 that require such an input. It should be noted that the present disclosure is described in detail in connection with the wheel tractor scraper 101. However, the disclosure may be utilized on any other such machine without deviating from the scope of the present disclosure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for a machine operating on a slope, the machine having an implement, the system comprising:
an implement position sensor configured to generate a signal indicative of a position of the implement relative to a frame of the machine;
an inclination sensor mounted on the implement, the inclination sensor configured to generate a signal indicative of an inclination of the implement relative to the frame of the machine; and
an inclination module communicably connected to the implement position sensor and the inclination sensor, the inclination module configured to:
receive the signal indicative of the position of the implement relative to the frame of the machine;
receive the signal indicative of the inclination of the implement relative to the frame of the machine;
correlate the position of the implement and the inclination of the implement with a predefined dataset to determine a bias factor associated with the implement; and
determine an inclination angle of the slope based on the determined bias factor.

2. The system of claim 1, wherein the inclination sensor includes at least one of an inclinometer, an accelerometer, a gyro sensor, and an orientation sensor.

3. The system of claim 1, wherein the predefined dataset contains readings of the inclination of the implement relative to the frame of the machine corresponding to one or more positions of the implement relative to the frame of the machine, when the machine is operating on horizontal ground.

4. The system of claim 1, wherein the machine includes a wheel tractor scraper.

5. The system of claim 4, wherein the implement position sensor is configured to generate a signal indicative of an extension of a cylinder associated with movement of a bowl of the wheel tractor scraper.

6. The system of claim 4, wherein the inclination sensor is configured to generate a signal indicative of an inclination of the bowl relative to the frame of the wheel tractor scraper.

7. The system of claim 1, further including a display unit communicably connected to the inclination module, the display unit configured to display the determined inclination angle of the slope.

8. A method for a machine operating on a slope, the machine having an implement, the method comprising:
receiving, from an implement position sensor, a signal indicative of the position of the implement relative to a frame of the machine;
receiving, from an inclination sensor mounted on the implement, a signal indicative of an inclination of the implement relative to the frame of the machine;
correlating the position of the implement and the inclination of the implement with a predefined dataset to determine a bias factor associated with the implement; and
determining an inclination angle of the slope based on the determined bias factor.

9. The method of claim 8, wherein the predefined dataset contains readings of the inclination of the implement relative to the frame of the machine corresponding to one or more positions of the implement relative to the frame of the machine, when the machine is operating on horizontal ground.

10. The method of claim 8 further comprising displaying the determined inclination angle of the slope.

11. A computer based system for a machine operating on a slope, the machine having an implement, the computer based system comprising:
a communication interface communicating with a memory;
the memory configured to communicate with a processor; and
the processor, in response to executing a computer program, performs operations comprising:
receiving, from an implement position sensor, a signal indicative of a position of the implement relative to a frame of the machine;
receiving, from an inclination sensor mounted on the implement, a signal indicative of an inclination of the implement relative to the frame of the machine;
correlating the position of the implement and the inclination of the implement with a predefined dataset to determine a bias factor associated with the implement; and
determining an inclination angle of the slope based on the determined bias factor.

12. The computer based system of claim 11, wherein the predefined dataset contains readings of the inclination of the implement relative to the frame of the machine corresponding to one or more positions of the implement relative to the frame of the machine, when the machine is operating on horizontal ground.

13. The computer based system of claim 11, wherein the operations performed by the processor further comprises displaying the determined inclination angle of the slope.
